(19) United States
(12) Patent Application Publication
(10) Pub. No.: US 2007/0130042 A1
(43) Pub. Date: Jun. 7, 2007

(54) SYSTEMS AND METHODS FOR STRUCTURING AND CONDUCTING A PUBLIC OFFERING OF EQUITY SECURITIES

(76) Inventor: Edward Joseph Dryden, Laredo, TX (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/565,994

(22) Filed: Dec. 1, 2006

Related U.S. Application Data
(60) Provisional application No. 60/741,796, filed on Dec. 1, 2005.

(51) Int. Cl. G06Q 40/00

(52) U.S. Cl. 705/36 R

(57) ABSTRACT

Disclosed herein are exemplary embodiments of a tax efficient manner for rewarding initial public offering inventors of a successful business, reducing commission expenses of secondary offerings used to finance the growth of the business, and shifting a large proportion of the rewards of the corporation's success to the initial public offering investors. A paired bid of an investment unit may be placed from a combination of a taxable account and a tax-advantaged account. Investment unit may include at least one share of common stock and a warrant. The warrant may include a right to buy at least one of a share of common stock and a warrant.

### CROSS-REFERENCE TO RELATED APPLICATION

This application claims priority to copending U.S. provisional application entitled, “System, Method, Process, and Procedure For Structuring And Conducting a Public Offering of Equity Securities,” having Ser. No. 60/741,796, filed Dec. 1, 2005, which is entirely incorporated herein by reference.

### TECHNICAL FIELD

The present disclosure is generally related to financial investments and, more particularly, is related to systems and methods for performing a sale of investment units.

### BACKGROUND

An initial public offering (IPO) may be used by a corporation to generate capital for the business. An IPO is the first sale of a corporation's common shares to public investors. While IPOs are effective at raising capital, they also impose heavy regulatory compliance and reporting requirements. An IPO refers to the first public issuance of a company's shares; any later public issuance of shares is referred to as a secondary market offering. A shareholder selling its existing shares (rather than shares newly issued to raise capital) to the public on the Primary Market is an Offer for Sale.

IPOs generally involve one or more investment banks as “underwriters.” The company offering its shares, called the “issuer,” enters a contract with a lead underwriter to sell its shares to the public. The lead underwriter then forms a group or syndicate of other underwriters who jointly approach investors with offers to sell these shares. The sale (that is, the allocation and pricing) of shares in an IPO may take several forms.

One particular form of an IPO may be called a “Dutch auction IPO” such as, for instance, the Dutch auction IPO of Google (herein, also Google IPO) that was conducted by Google and selected underwriters on Aug. 18, 2004. A drawback of the Google IPO is that that IPO did not allow an individual investor with both taxable cash and/or margin accounts and tax-advantaged stock brokerage accounts such as a Roth IRA to use taxable accounts to leverage the tax-advantaged accounts. A tax advantaged account refers to an investment account that, per Internal Revenue Service regulations, receives more favorable treatment of income, dividends, interest, and capital gains than those received by taxable accounts. This more favorable treatment is a multi-year deferral of the payment of taxes on current income in the case of regular IRAs, 401Ks and 403Bs, and a permanent complete exemption from taxes in the case of Roth IRAs.

For instance, in the example of the Google IPO, an individual can bid to purchase Google shares in both the taxable stock brokerage account and a tax-advantaged account. But, the tax-advantaged account receives no benefit from the bid and/or IPO participation of the same individual's taxable accounts.

### SUMMARY

Embodiments of the present disclosure provide systems and methods for structuring and conducting a public offering of equity securities. One method embodiment, among others, includes structuring an investment unit comprising at least one share of common stock and at least one warrant, the warrant comprising a right to purchase at least one of a right to purchase one share of common stock and a warrant; and performing an offering of the investment unit.

Another embodiment of such a method, among others, can be broadly summarized by the following: establishing a paired bid account comprising a taxable account and a tax-advantaged account; and placing an offer for investment units using the paired bid account.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a system embodiment for structuring and conducting a public offering of equity securities.

FIG. 2 is a flow diagram of a method embodiment of structuring and conducting a public offering of equity securities using the system of FIG. 1.

FIG. 3 is a flow diagram of a method embodiment of buying a public offering of equity securities using the system of FIG. 1.

FIG. 4 is a spreadsheet of financial aspects of the method of FIG. 2.

FIG. 5 is a spreadsheet of financial aspects of the method of FIG. 2.

FIG. 6 is a spreadsheet of financial aspects of the method of FIG. 2.

FIG. 7 is a spreadsheet of financial aspects of the method of FIG. 2.

### DETAILED DESCRIPTION

This disclosure provides systems and methods for providing a tax efficient manner for rewarding initial public offering investors of a successful business, reducing the commission expenses of secondary offerings used to finance the growth of the business, and shifting a large proportion of the rewards of the corporation's success to the initial public offering investors. Such systems and methods of structuring and conducting a public offering of equity securities finance both the growth of capital of the corporation and the future participation in the corporation's growth by the initial public offering investors. These systems and methods also allow for the initial public offering investors to protect themselves from dilution of their percentage ownership of a corporation without investing additional out-of-pocket cash after an initial investment due to the additional investment being financed by a margin account in combination with the appreciation of the corporation's common stock market price.

Because IRS regulations limit the permissible contributions of capital to a tax-advantaged account, such as a Roth IRA, a traditional IRA, a 401k and/or a 403b, an individual investor with large securities investment account balances may have much larger capital balances in taxable accounts than in tax-advantaged accounts, such as Roth IRAs. Cash and margin accounts, as well as stock brokerage enabled Roth IRA accounts, traditional IRAs, individual retirement accounts per internal revenue service regulations, 401k, 403b, and other types of income tax deferred and/or income tax free accounts may be referred to collectively or individually as “tax-advantaged” accounts. A tax-advantaged account comprises an investment account that, per Internal Revenue Service regulations, receives more favorable treatment of income, dividends, interest, and capital gains than those received by taxable accounts. Other non-limiting examples of tax-advantaged accounts include company pension funds such as the GE pension fund and the UAW pension fund. Although IRS regulations severely limit the contributions of capital to a tax-advantaged account, the regulations do not limit the growth of capital in that account.

Embodiments of the disclosed systems and methods for structuring and conducting a public offering of equity securities take advantage of the subtle distinction between IRS regulations of the contribution of capital and the absence of IRS regulations on the growth of capital to use the holdings of capital in the taxable accounts (where IRS regulations do not limit such capital contributions) to increase the growth of capital in tax-advantaged accounts (where IRS regulations permit such capital growth). Such systems and methods also moderate the growth of capital in regular capital accounts (where it is taxed) and increases the growth of capital in tax-advantaged accounts (such as Roth IRAs, where it is not taxed if not withdrawn prematurely).

To take advantage of IRS regulations, a paired bid may be placed in the purchase of investment units. A paired bid refers to a coordinated bid by 2 or more stock brokerage accounts that are under common ownership (such as, for example, a cash account for an individual and a Roth IRA account of the same individual), under common control, or being operated by separate entities under a joint operating agreement and/or contract.

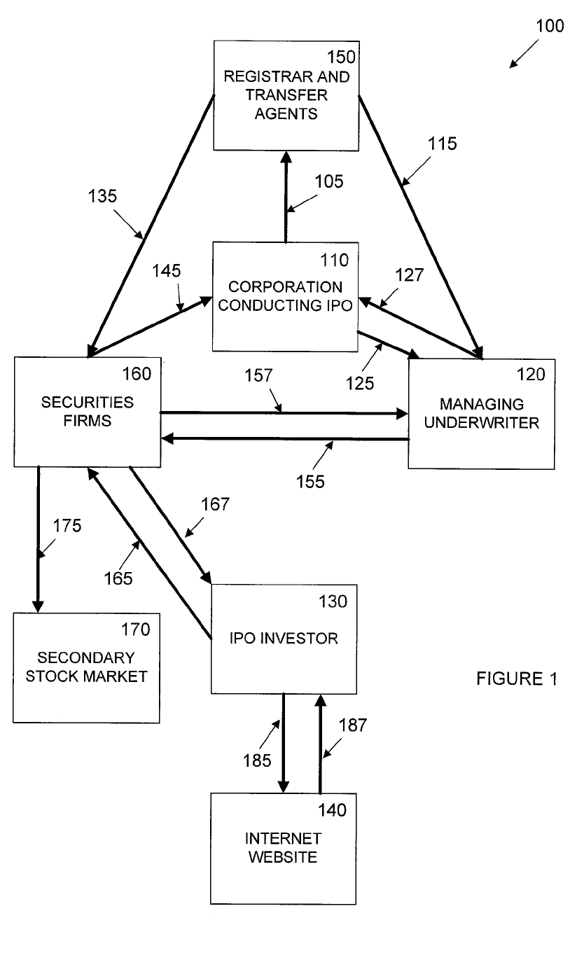

One exemplary system 100 for structuring and conducting a public offering of equity securities is provided in FIG. 1. System 100 comprises corporation 110 conducting the initial public offering, as a non-limiting example, Google; managing underwriter 120, as a non-limiting example, Goldman Sachs & Co.; IPO investor 130; Internet web site 140 used to comply with NYSE “know your customer rule” and used to select approved IPO participating investors based on the IPO Corporation's criteria for desirable shareholders; registrar and transfer agents 150 of IPO corporation 110; secondary trading stock market 170, as non-limiting examples, the New York Stock Exchange, the American Stock Exchange, and the NASDAQ; and securities firms 160 used by IPO investors 130 to carry their taxable and non-taxable accounts.

An underwriting agreement using system 100 for structuring and conducting a public offering of equity securities includes transaction 125 from corporation 110 conducting the IPO to managing underwriter 120. Potential IPO investors 130 may log onto IPO web site 140 using transaction 185, filling in a form and questionnaire on IPO web site 140. An approved bidder ID PIN (identification Personal Identification Number) may be furnished through transaction 187 to potential IPO investor 130 who has been approved to bid on the IPO.

An execution and funding of the taxable and tax-advantaged accounts agreements (i.e. opening of the accounts that will be used by the IPO investors to bid for IPO units) may be performed through transaction 167. A bid for IPO units by approved investors may be performed through transaction 165. A bid for IPO units by approved investors together with their approved IPO participants ID PINs is performed through transactions 157, 127. An acceptance of IPO bids accepted by the IPO corporation 110 is performed through transactions 125, 155, 167. A payment for the IPO units sold by IPO corporation 110 and purchased by IPO investor 130 is performed through transactions 175, 127.

Exemplary embodiments of systems and methods for structuring and conducting a public offering of equity securities may include warrants. A warrant may include a right to buy a share of common stock. Exemplary embodiments of systems and methods for structuring and conducting a public offering of equity securities may also include “snowballing warrants.” Snowballing warrants are warrants that, instead of merely entitling the warrant holder to purchase common shares of an issue at a fixed price within a fixed pre-set amount of time, entitle the warrant holder to purchase units of securities that are composed both of common shares and other warrants. The other warrants may themselves be snowballing warrants entitling the holder to exercise the warrants for a combination of stock shares and warrants.

A delivery of the securities of the IPO units purchased may be performed through transactions 105, 115, 155. A sale of the common shares portion of the IPO units by IPO investor 130 who only wants to own a warrant long term may be performed through transactions 165, 175. An exercise of the snowballing warrants may be performed through transactions 165, 145. A delivery of the securities purchased by the exercise of the snowballing warrants may be performed through transactions 105, 135.

In a preferred embodiment, non-limiting examples of a corporation 110 may include a real estate investment trust, partnership, and/or limited liability company wishing to raise additional capital via an initial public offering and/or secondary offering of equity securities or debt securities that are combined with equity securities. A present or prospective investor and/or shareholder who has, or can open, both taxable and tax-advantaged stock brokerage accounts may wish to invest in the initial public offering or secondary offering.

Non-limiting examples of securities firm 160 may include a stock broker who is insured by the Security Investors' Protection Corporation (SIPC) and by private insurance, for example, or surety companies for amounts in excess of the coverage of the SIPC, and whose accounts are accessible for both inquiries and trading via the Internet may participate in the trade offering or underwriting. Also included within the scope of securities firm 160 are securities firms whose accounts are accessible for both inquiries and trading via phone and in person and whose accounts are not insured by Security Investors' Protection Corporation and by private insurance or surety companies for amounts in excess of the SIPC insurance coverage.

Exemplary embodiments of transactions may include a password and associated investor identification number and email account that can be used to enter trades into a computer system of the securities firm or stock broker and that can be used to participate in a Dutch auction Initial Public Offering that has been modified and enhanced to permit paired bids from taxable and non-taxable account.

Nonlimiting exemplary embodiments of website 140 may include websites that can be used to gather indications of interest for potential IPO investors, gather information to comply with the “Know Your Customer Role” of the New York Stock Exchange, and to process their indication of interests pursuant to the criteria of the issuing entity for accepting new investors and/or shareholders and gather account email information, stock brokerage accounts information, and other information needed to accept paired bids. Exemplary embodiments of transactions may include include paired bids in all necessary computer processes, systems, and programs, to accept and process paired bids.

In an exemplary embodiment, a paired bid may be entered for a “unit offering”. For example, an offering of a unit composed of one share of common stock and an “A” warrant comprising a stock and warrant purchase. A paired bid may also be entered by 2 or more accounts. For example, Mr. John Smith has both a cash brokerage account and a Roth IRA account at a participating underwriter. Mr. Smith could make a paired bid of $85 for a unit composed of one share of common stock of ABC corporation and one “A” warrant of ABC corporation. In accepting or rejecting the paired bid, ABC corporation may look at only the total of $85 for the unit offering and not at the individual components of the bid.

Continuing with the example, if the total bid of $85 is accepted by the ABC corporation, Mr. John Smith may inform a participating underwriter that a paired bid of $85/unit for 100 units is composed of $70/unit from a cash account for a common share portion of the unit and $15/unit from a Roth IRA account for the “A” warrant portion of the unit, and that the cash account and Roth IRA are to be charged accordingly. The different securities are preferably deposited in the two accounts accordingly. That is, in this example, the cash account should be charged $7,000 for buying 100 common shares and the Roth IRA account should be charged $1,500 for buying 100 “A” warrants.

Included in an exemplary embodiment of systems and methods for structuring and conducting a public offering of equity securities may be one or more firms that act as a transfer agent for the stock and/or shares of publicly traded corporations. One exemplary embodiment includes one or more margin accounts and/or cash accounts at one or more of the securities or stock brokerage firms mentioned above that are suitable for the “cashless exercise” of the warrants in a manner similar to the “cashless exercise” of employee stock options. On the same trading day and at almost the same time, a securities stock brokerage company may exercise the warrants on behalf of the warrant holder and sell enough of the shares purchased pursuant to the exercise of the warrant to pay for the exercise and/or pay for the shares purchased pursuant to the exercise of the warrant and for the commissions and/or fees charged by the stock brokerage firm. A margin account may be a securities account where the securities firm is willing to loan money and/or shares subject to the margin regulation of the Federal Reserve. One or more cash accounts may be included at one or more of the securities or stock brokerage firms mentioned above. A cash account refers to a securities account where the securities firm is not willing to loan money and/or shares subject to the margin regulation of the Federal Reserve.

Exemplary embodiments may also include computer systems and computer programs owned and operated by the securities firms or stock brokerage firms. Exemplary embodiments may also include computer systems and computer programs owned and/or used and phone systems operated and/or used by the investor and investors participating in offering of securities. Exemplary embodiments may also include the Internet, the national and international telephone systems, postal services of the United States and other countries for transactional business. Exemplary embodiments may also include various securities exchanges and over-the-counter stock markets where publicly traded stocks and real-estate investment trusts can be bought or sold through stock brokers.

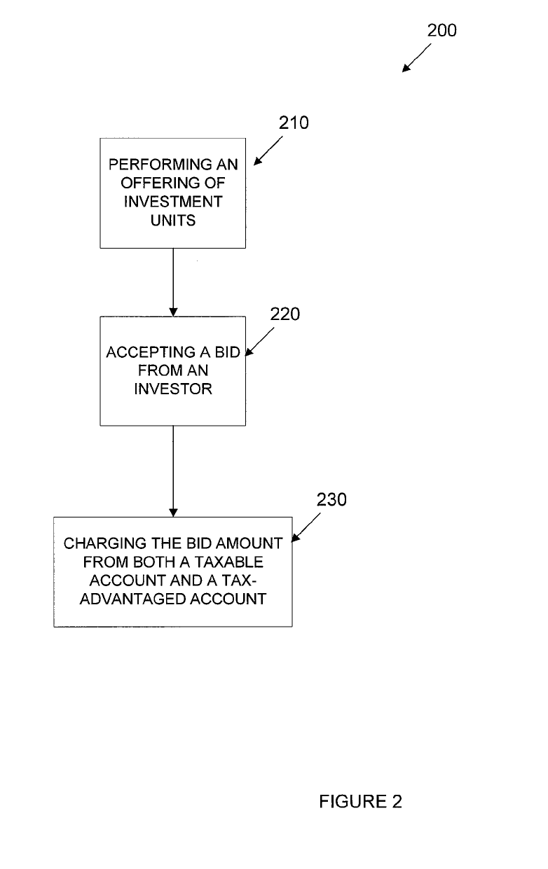

Flowchart 200 of FIG. 2 demonstrates an exemplary embodiment of a method for structuring and conducting a public offering of equity securities as disclosed herein. In block 210, an offering of investment units is performed by corporation 110. In block 220, a bid is accepted from an investor. In block 230, the bid amount is charged by securities firm 160 from both a taxable account and a tax-advantaged account.

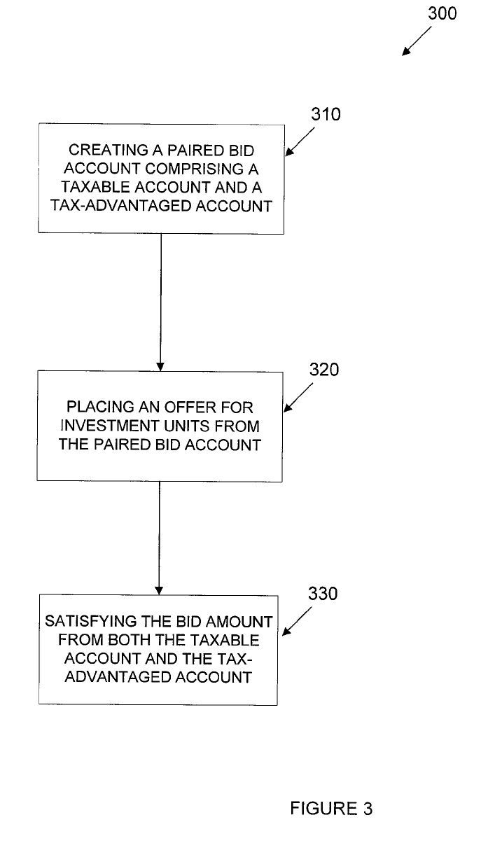

Flowchart 300 of FIG. 3 demonstrates a method of purchasing investment units through a method for structuring and conducting a public offering of equity securities as disclosed herein. In block 310, a paired bid account is created by IPO investor 130. The paired bid account may comprise a taxable account and a tax-advantaged account. A paired bid account is not limited to a taxable account and a tax-advantaged account combination, and may comprise other accounts that offer other financial advantages. In block 320, an offer for investment units is placed from the paired bid account by investor 130. In block 330, the bid amount is satisfied from both the taxable and the tax advantaged accounts.

In the example of the Google IPO, using the closing price of Google as of Nov. 24, 2006, of $505.00, an investment of $10,000 allows an individual investor to use $7,500 in a taxable security stock brokerage account to leverage $2,500 in a tax-advantaged Roth IRA stock brokerage account to share total capital appreciation of $253,890.00 disproportionately with the taxable account. This arrangement accumulates $51,640.00, or 20.34% of the total appreciation, while contributing 75% of the total initial capital investment. The tax-advantaged Roth IRA securities account, accumulates $202,250.00, or 79.66% of the capital appreciation, while contributing only 25% of the total initial capital investment by both accounts.

In contrast, in the case of the actual historical Google IPO, if the taxable account had invested 75% of $10,000 and the Roth IRA had invested 25% of $10,000, the taxable account would have experienced a profit of $36,855.00, or 75% of the total profit, and the Roth IRA a profit of $12,285.00, or 25% of the total profit. Thus, the individual investor would have received no benefit and/or leverage for a tax-advantaged account as a result of buying Google in both types of accounts.

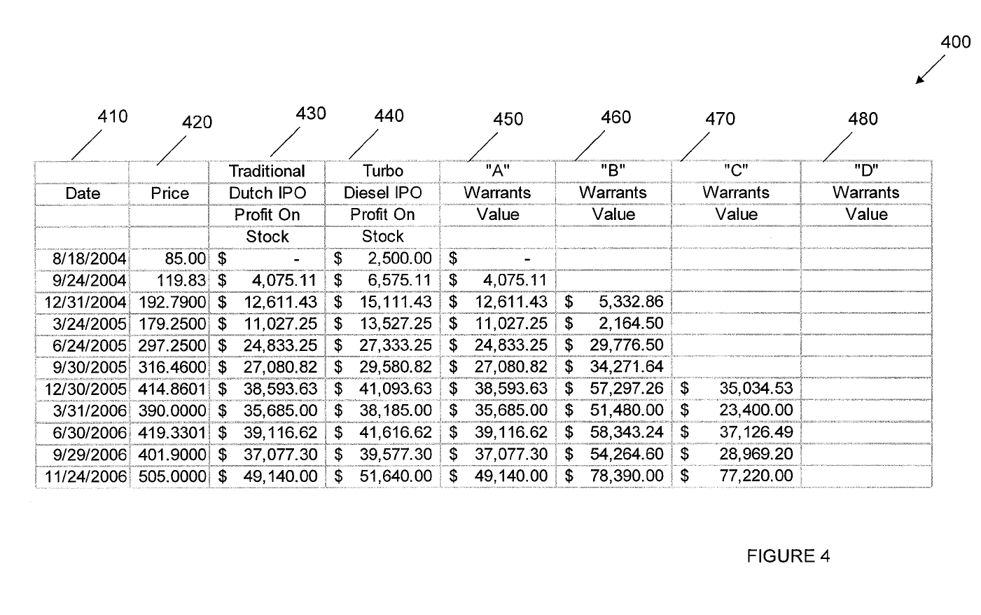

FIGS. 4-7 contain detailed spreadsheets 400, 500, 600, 700 with financial details of the contrast described above between a Dutch auction and systems and methods for structuring and conducting a public offering of equity securities as disclosed herein. Referring to FIG. 4, column 410 contains the dates on which the status of the exemplary systems are contrasted. Column 420 contains the market price that Google closed on the dates of column 410.

Column 430 demonstrates the amount of profit that an investor who had participated in the Google IPO to the amount traditionally used in examples, i.e. $10,000.00, would have experienced. Because Google went public at $85 per share and $10,000.00 is not an even multiple of $85.00 the investor would have 117 shares of Google and have $55.00 left over from the $10,000.00. Column 430 is calculated by multiplying the 117 shares of stock by the difference in the price at the corresponding date in column 410 and the price of the IPO on Aug. 18, 2004.

Column 440 demonstrates the amount of profit that an investor who had participated in the Google IPO performed with systems and methods for structuring and conducting a public offering of equity securities as disclosed herein. These systems and methods use the same $10,000, resulting in the same 117 shares, but at a lower assumed cost. The lowest cost results because only $7,500 of the $10,000 would be allocated to the stock and $2,500 would be allocated to the “A” warrants. Thus the profit is higher by $2,500.00.

Column 450 demonstrates the amount of profit that an investor who had participated in the Google IPO performed with systems and methods for structuring and conducting a public offering of equity securities as disclosed herein would have experienced on the “A” warrant with a cost basis of $2,500.00 dollars allocated to 117 “A” warrants.

Column 460 demonstrates the amount of profit that an investor who had participated in the Google IPO performed with systems and methods for structuring and conducting a public offering of equity securities as disclosed herein would have experienced on the “A” warrant due to the value of the “A” warrants. The value of the “A” warrants is attributable to the fact that each “A” warrant entitles the holder to purchase two “B” warrants, and each “B” warrant entitles the holder to purchase a share of Google from Google for $170 for each “B” warrant. Thus, when the price of Google surpasses $170 per share, the “A” warrants start selling for an additional value based on their right to two “B” warrants.

Column 470 demonstrates the amount of profit that an investor who had participated in the Google IPO performed with systems and methods for structuring and conducting a public offering of equity securities as disclosed herein would have experienced on the “A” warrant. The value of the “A” warrants may be attributable to the fact that each “A” warrant entitles the holder to purchase four “C” warrants and the “C” warrants entitle the holder to purchase a share of Google from Google for $340 for each “C” warrant. Thus, when the price of Google goes above $340 per share the “A” warrants start selling for an additional value based on their right to four “C” warrants.

Column 480 demonstrates the amount of profit that an investor who had participated in the Google IPO performed with systems and methods for structuring and conducting a public offering of equity securities as disclosed herein would have experienced on the “A” warrant. The value of the “A” warrants may be attributable to the fact that each “A” warrant entitles the holder to purchase eight “D” warrants and the “D” warrants entitle the holder to purchase a share of Google from Google for $680 for each “D” warrant. Thus, when the price of Google goes above $680 per share the A warrants start selling for an additional value based on their right to eight “D” warrants.

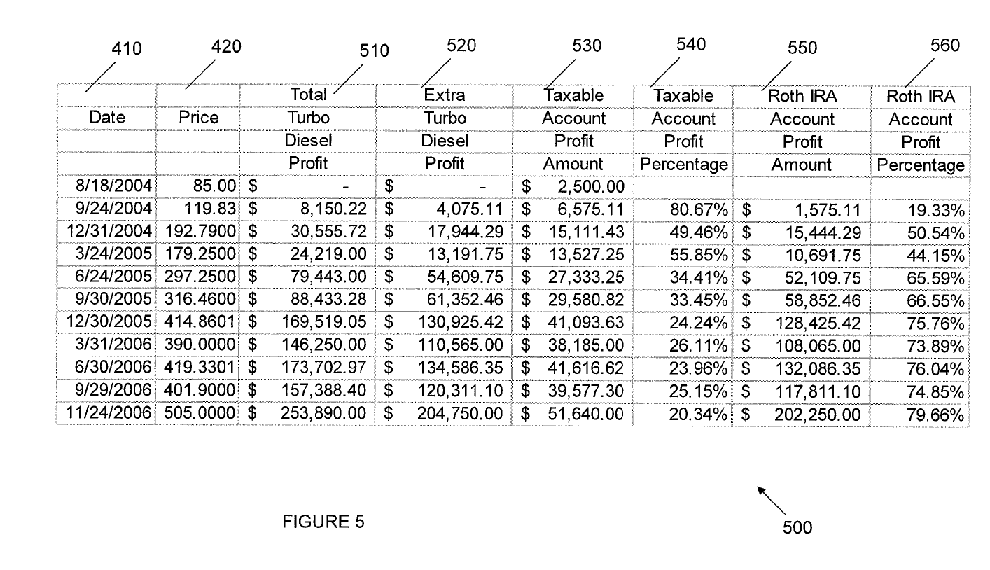

Referring to FIG. 5, column 510 demonstrates the amount of profit that an investor who had participated in the Google IPO performed with systems and methods for structuring and conducting a public offering of equity securities as disclosed herein and not the way it was actually done would have experienced on the stock, i.e. common shares purchased in the unit plus the “A” warrants, plus the value of the “A” warrants due to the “B” warrants and the value of the “A” warrants due to the “C” warrants and the value of the “A” warrants due to the value of the “D” warrants.

Column 520 demonstrates the extra amount of profit that an investor who had participated in the Google IPO performed with systems and methods for structuring and conducting a public offering of equity securities as disclosed herein would have experienced compared to the same investor investing $10,000 in the manner that the Google IPO was actually done.

Column 530 demonstrates the amount of profit that an investor who had participated in the Google IPO performed with systems and methods for structuring and conducting a public offering of equity securities as disclosed herein would have experienced in the taxable account.

Column 540 demonstrates the percentage of total profit that an investor who had participated in the Google IPO performed with systems and methods for structuring and conducting a public offering of equity securities as disclosed herein would have experienced in the taxable account.

Column 550 demonstrates the amount of profit that an investor who had participated in the Google IPO performed with systems and methods for structuring and conducting a public offering of equity securities as disclosed herein would have experienced in the tax advantaged account.

Column 560 demonstrates the percentage of total profit that an investor who had participated in the Google IPO performed with systems and methods for structuring and conducting a public offering of equity securities as disclosed herein would have experienced in the tax advantaged account.

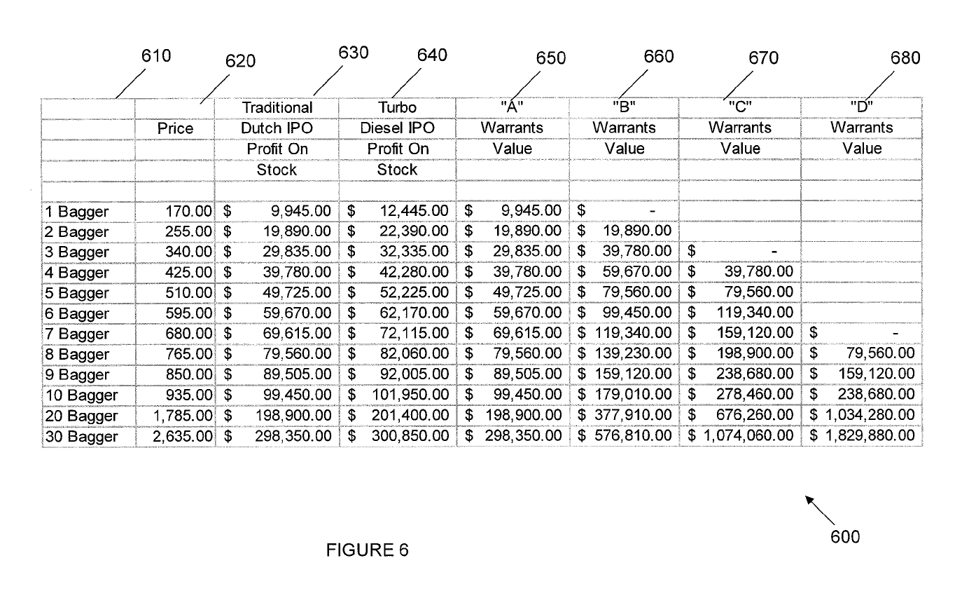

Referring to FIG. 6, Column 610 contains an amount of profit in bagger units. The term “bagger” was coined by a portfolio manager for Fidelity Magellan Fund. Each bagger is equal to 100% profit. So, a one bagger stock has a 100% profit and a price equal to 200% of its cost price or basis. A ten bagger has a 1,000% profit and a market price equal to 1,100% of its cost basis. A thirty bagger has a 3,000% profit and a market price equal to 3,100% of its cost.

Column 620 demonstrates the price that would correspond to the profit level indicated by the “bagger” number in column 610. Column 630 demonstrates an amount of profit based on the “bagger” number or level in column 610. Column 640 demonstrates an amount of profit corresponding to the “bagger” number or level in column 610.

Column 650 demonstrates an amount of profit on the “A” warrant based on the “bagger” number or level in column 610. Column 660 demonstrates an amount of profit on the “B” warrants based on the “bagger” number or level in column 610. Column 670 demonstrates an amount of profit on the “C” warrants based on the “bagger” number or level in column 610. Column 680 demonstrates an amount of profit on the “D” warrants corresponding to the “bagger” number or level in column 610.

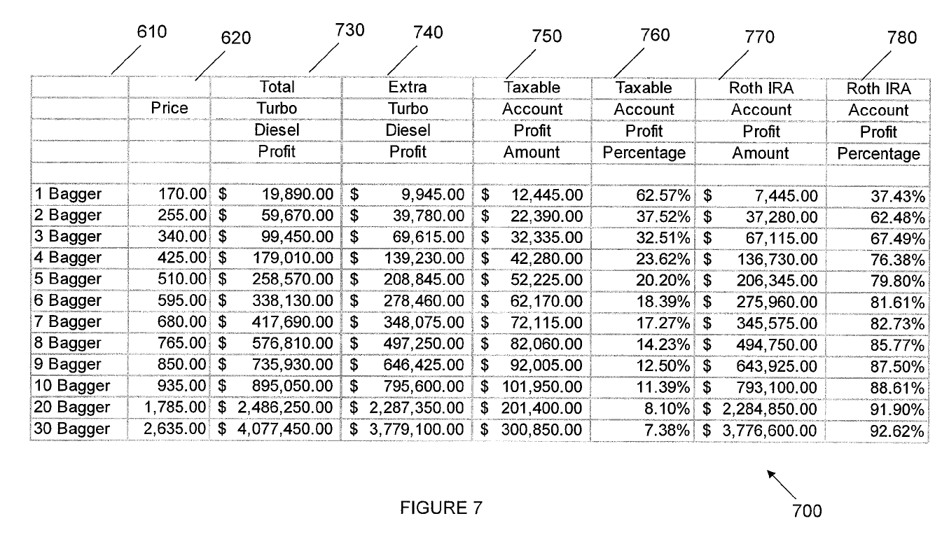

Referring to FIG. 7, column 730 demonstrates the profit that an investor who had participated in the Google IPO performed with systems and methods for structuring and conducting a public offering of equity securities as disclosed herein would have experienced in his taxable account based on the price level of the common stock corresponding to the number of “baggers” in column 610.

Column 740 demonstrates the percentage of total profit that an investor who had participated in the Google IPO performed with systems and methods for structuring and conducting a public offering of equity securities as disclosed herein would have experienced in his taxable account based on the price level of the Common Stock that would correspond to the number of “baggers” in column 610.

Column 750 demonstrates the profit that an investor who had participated in the Google IPO performed with systems and methods for structuring and conducting a public offering of equity securities as disclosed herein would have experienced in his taxable account based on the price level of the common stock that correspond to the number of “baggers” in column 610.

Column 760 demonstrates the percentage of total profit that an investor who had participated in the Google IPO performed with systems and methods for structuring and conducting a public offering of equity securities as disclosed herein would have experienced in the taxable account based on the price level of the common stock that correspond to the number of “baggers” in Column 610.

Column 770 demonstrates the profit that an investor who had participated in the Google IPO performed with systems and methods for structuring and conducting a public offering of equity securities as disclosed herein would have experienced in his tax-advantaged account (a non-limiting example of a Roth IRA account) based on the price level of the common stock that correspond to the number of “baggers” in column 610.

Column 780 demonstrates the percentage of total profit that an investor who had participated in the Google IPO performed with systems and methods for structuring and conducting a public offering of equity securities as disclosed herein would have experienced in the tax-advantaged account (a non-limiting example of a Roth IRA account) based on the price level of the common stock that correspond to the number of “baggers” in Column 610.

Traditional or ordinary stock purchase warrants are also envisioned to be within the scope of this disclosure that allow a warrant holder to purchase a common stock of the issuer at a fixed price within a fixed time frame. An exemplary embodiment also includes a password and an associated investor identification number and email account that can be used to enter trades into the computer system of the securities firm or stock broker and that can be used to participate in a Dutch auction initial public offering. In exemplary embodiments, these identification numbers may identify two or more accounts that are bidding a combined total of a certain amount for a unit offering comprising two or more securities.

For instance, if a total of $85 is being bid for a unit of one share of common stock and one warrant, a particular identification number is known to a participating underwriter carrying the accounts used to bid $75 to be paid by an individual's cash account and a share to be purchased in the cash account and $15 to be paid by an individual's Roth IRA account. The warrant is to be purchased by the Roth IRA and placed in the Roth IRA account. In one implementation, the issuer, the issuing corporation, the real estate investment trust, partnership, and/or limited liability company only sees the total bid for the unit of one share and one warrant. The investment units may be carried in the street name of the securities firm until such time as they are separately transferable and can be separately registered and separately transferred in the books of the issuer by the registrar and transfer agent of the issuer. One or more firms may act as a registrar for the stock and/or shares of publicly traded corporations.

In an exemplary embodiment of systems and methods for structuring and conducting a public offering of equity securities, an issuer of securities who wants to raise capital selects or decides on the structure of the initial unit public offering and the number, kind, exercise price, and rights of the snowballing warrants and regular or traditional warrants. For example, a corporation decides that the initial unit will be composed of one share of common stock and one class “A” warrant. The issuer will accept auction bids for the unit between $100 and $85 per unit and will decide how many initial units to sell at a defined unit price based on the bids that the issuer receives.

The issuer may also decide that the “A” warrant can be exercised at anytime within three years of the initial offering by payment of $85 and that the payment of the $85 will purchase one share of common stock and two class “B”warrants.

The issuer may also decide that the “B” warrant can be exercised at anytime within an additional four years from the date of the expiration of the original “A” warrant (a total of seven years from the date of the IPO) by the payment of $170. The payment of the $170 will purchase one share of common stock and two class “C” warrants.

The issuer may also decide that the “C” warrant can be exercised at anytime within an additional five years from the date of the expiration of the original “B” warrant (a total of twelve years from the date of the IPO) by the payment of $340 and that the payment of the $340 will purchase one share of common stock and two class “D” warrants.

The issuer may also decide that the “D” warrant can be exercised at anytime within an additional six years from the date of the expiration of the original “C” warrant (a total of 18 years from the date of the IPO) by the payment of $680 and that the payment of the $680 will purchase one share of common stock.

In the above example, the IPO entailed an original unit offering of one share of common stock and one snowballing class “A” warrant. The structure may also call for snowballing class “B” and class “C” warrants and traditional class “D” warrants. In actual practice, the number, kind, expiration periods, and exercise rights in terms of number of shares and other warrants can be varied almost to an infinite number of combinations.

Once the issuer decides on the structure as detailed above, the issuer may make arrangements for a firm or firms in the business of the transfer and registration of securities to agree to act as registrar and/or transfer agent of the common stock and warrants involved in its offering. The issuer may also make arrangements with one or more securities exchanges to list its common stock and warrants on those securities exchanges. The issuer may secure one or more interested stock brokerage firms to act as an underwriter or underwriting syndicate for the auction IPO of the issuer according to embodiments of the disclosed systems and methods for structuring and conducting a public offering of equity securities.

The issuer may advertise on a website owned, operated and maintained by the names and contact information of the participating underwriters. The issuer may use an authorization procedure for obtaining a bidder ID personal identification number (PIN), and a form that can be filled out online by a perspective bidder. The authorization procedure may be used by the participating underwriters to comply with the “Know Your Customer” rule and the suitability securities industry regulations, and to determine if the investor profile of the prospective bidder conforms to the type and kind of investor to whom it may offer securities.

Once a prospective investor obtains a bidder ID PIN, the investor may check the list of participating underwriters to select a firm among the participating underwriters and open a taxable and a tax-advantaged account in order to participate in the auction IPO according to the systems and methods for structuring and conducting a public offering of equity securities as disclosed herein. The taxable account may be opened by filling out appropriate account opening and account agreement forms and then by depositing funds in such an account. However, in some implementations, the tax-advantaged account may require that the investor make arrangements to open a tax-advantaged account and also have the participating underwriting firm arrange for a transfer of the cash and securities of an existing tax-advantaged account from another stock brokerage firm that is carrying the investor's tax-advantaged account.

The arrangements for opening a tax-advantaged account are analogous to a cash or margin account form although both cash and margin accounts may have different forms and different information may be required. The IRA accounts, whether Roth or regular, have extra requirements such as the naming of a beneficiary and a signature of a spouse for disclaiming any ownership in the account. The disclaimer may address community property issues that may arise if the IRAs are set up as individual accounts of a community property state resident.

Also, the tax-advantaged account may not always be funded from an individual's checking account since the individual might have already used up his limit for contributions to a tax advantage account for that year. Alternatively, he might have no allocation permitted due to having met the maximum earnings or contribution level. In these examples, a new IRA may have to be funded by transferring funds from IRA accounts at other brokers or by transferring IRA accounts from other brokers who are not participating in the underwriting and can not accept IPO bids.

Once a prospective investor has funded (in some cases by transfers from other security firms) both taxable and tax-advantaged accounts, the investor may enter the account numbers of these accounts into the computer system of the participating underwriter carrying the accounts. In turn, the investor may receive from the participating underwriter a paired bidder's ID that associates both accounts. The underwriter may also associate both accounts with the investor's original ID issued by the issuer conducting the auction IPO according to the systems and methods for structuring and conducting a public offering of equity securities as disclosed herein.

Next, the prospective investor uses a paired bidder's ID to inform a stock broker which percentage of the total paired bid is to be charged to or paid for from the respective accounts and the amount that each of the paired accounts is to be charged. For instance, the paired bidder's ID may be used to inform a participating underwriter of a paired bid of $8,500 for 100 units, where $7,000 is to be charged to the investor's cash account in payment for the 100 shares of common stock of the 100 units and $1,500 is to be charged to the Roth IRA in payment for the 100 class “A” warrants of the 100 units.

Next, when the securities and exchange commission declares that the registration for the units' offering is effective and the issuer and participating underwriter determine that the market circumstances and environment make the IPO feasible, the auction IPO, performed according to systems and methods for structuring and conducting a public offering of equity securities as disclosed herein, includes the IPO offerer examining proposed bids for the offered investment units. The offerer then determines the price at which all the units that the offerer (or issuer) may be sold and performs the IPO. The IPO may be restricted to include only the participating underwriters involved with clients who submitted paired bids.

At this stage, a client of a participating underwriter may also participate with the use of paired bids by making a simple bid for the units using a single account. An investor who is not entitled to have a tax-advantaged account can use a cash account to enter a paired bid of $70 per share and $15 per warrant from the same single cash account. This would result in the investor establishing a tax basis of $70 for the stock and $15 for the warrant and can lead to limited tax planning such as selling the stock quickly at no tax gain or even for a tax loss, meanwhile holding the warrant for long term appreciation.

According to exemplary embodiments, at a time that meets with the agreement of the exchanges involved, the units may be traded in a “secondary” market. Additionally, the components of the units, the common stock and warrants, may be traded on a “when issued” basis. Separate trading of the components can commence when the issuer and the issuer's registrar and transfer agents agree to transfer the components separately. At this time, the units may undergo a transfer from investment units to individual shares and warrants.

When regulations are complied with, the stock can become eligible for being “margined” in margin accounts and even to be purchased on margin and being sold short by borrowing in a margin account. After the warrants are exercisable, owners who acquired the warrants in the initial IPO or via secondary trading in the post IPO market, may use stock brokers to exercise their warrants. The exercise may be via cashless exercises or, alternatively, the full exercise price of the warrants may be paid in full to receive the common stock and warrants, if any, that the exercise entitles the warrant holder to receive pursuant to the exercise. The issuer may receive the proceeds of the exercises pursuant to the exercise price and terms.

These systems and methods achieve results using two securities with different risk versus reward profiles or characteristics instead of a single security like a common stock, a warrant, or a bond. For instance, if after the initial IPO, the price of the common stock traded at a price equal to one half of the IPO unit price for 10 years, an investor in a conventional auction IPO would have an investment worth one half of the investment. However, an investor in the auction IPO as disclosed herein would have one account, the account that held the common stock, with investment securities equal in market value to one half of the total investment in the IPO unit and in another account, securities that have expired as worthless. If, on the other hand, for instance, after the initial IPO, the price of the common stock traded at a price equal to 11 times the IPO price in a conventional IPO, the conventional IPO investor would hold shares of common stock worth 11 times the original IPO investment. Per the FIG. 1, this investor would have a profit of $99,450 plus the original $10,000 capital contribution for a total value of $109,450.

On the other hand, under the same circumstances, that is, if for 10 years after the IPO, the common stock traded at a price equal to 11 times the IPO unit price of an auction IPO as described herein, the IPO investor would have in one account (the account that held the common shares) an investment, as shown in FIG. 5, with a profit of $101,950 plus the original $7,500 capital contribution in the common stock buy-in account for a total value of $109,450. In addition, the investor would have a security in the tax-advantaged account with a value of $795,600 which less the original capital contribution of $2,500 in the warrants buy-in account for a total profit of $793,100 on the warrants investment.

An alternative embodiment may include using units composed of bonds, stocks, and warrants and accepting paired bids that comprise or cover various components of the units being offered. Due to the many options and the features, the numbers of shares in the original IPO unit, the number and value faces of the bonds, the number of warrants, their exercise price, and their terms, etc., there are many ways and manners that the systems and methods disclosed herein can achieve the results. However, the example system used in FIG. 1 shows one preferred embodiment that illustrates various characteristics, mechanics, operations, and results of the systems and methods disclosed herein. The systems and methods disclosed herein open the door to more tax efficient investing by investors and more economical long-term increase of capital by issuers. The exercise of the warrants may not involve the payment of commissions and other fees to underwriters of secondary offerings that the issuer would have to undertake to raise capital in the absence of the warrant exercises.

Computers may be used to implement the various transactions. Embodiments or portions of embodiments of the present disclosure can be implemented in hardware, software, firmware, or a combination thereof. In the preferred embodiment(s), the structuring and conducting of a public offering of equity securities may be implemented in software or firmware that is stored in a memory and that is executed by a suitable instruction execution system. If implemented using hardware, as in an alternative embodiment, the structuring and conducting of a public offering of equity securities may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

The program for structuring and conducting of a public offering of equity securities, which may comprise an ordered listing of executable instructions for implementing logical functions, may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium may be, for example, but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of the present disclosure includes embodying the functionality of the preferred embodiments of the present disclosure in logic embodied in hardware or software-configured mediums.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

Therefore, at least the following is claimed:

1. A method comprising:
structuring an investment unit comprising at least one share of common stock and at least one warrant, the warrant comprising a right to purchase at least one of a right to purchase one share of common stock and a warrant; and
performing an offering of the investment unit.

2. The method of claim 1, further comprising accepting a bid from an investor, the bid comprising a unit price and an amount of units.

3. The method of claim 2, wherein the investor has a taxable account and a tax-advantaged account.

4. The method of claim 3, further comprising charging the bid amount from both the taxable account and the tax-advantaged account.

5. The method of claim 1, wherein the offering of investment units comprises an initial public offering.

6. A method comprising:
establishing a paired bid account comprising a taxable account and a tax-advantaged account; and
placing an offer for investment units using the paired bid account.

7. The method of claim 6, wherein at least one investment unit comprises at least one share of common stock and at least one warrant, the warrant comprising a right to purchase at least one of a right to purchase one share of common stock and a warrant.

8. The method of claim 6, wherein the offer comprises a bid with a unit price and an amount of units.

9. The method of claim 6, wherein the placing of the offer is in response to an initial public offering.

10. The method of claim 6, wherein the tax-advantaged account comprises one of a Roth IRA, a traditional IRA, a 401k account, and a 403b account.

11. A computer readable storage medium comprising:
logic for offering investment units, an investment unit comprising at least one share of common stock and at least one warrant, the warrant comprising a right to purchase at least one of a right to purchase one share of common stock and a warrant.

12. The computer readable storage medium of claim 11, further comprising logic for accepting a bid from an investor, the bid comprising a unit price and an amount of units.

13. The computer readable storage medium of claim 12, wherein the investor has a taxable account and a tax-advantaged account.

14. The computer readable storage medium of claim 13, further comprising logic for charging a bid amount from both the taxable account and the tax-advantaged account.
